(19) United States
(12) Patent Application Publication
(10) Pub. No.: US 2022/0172134 A1
(43) Pub. Date: Jun. 2, 2022

(54) METHODS AND APPARATUS FOR AUTOMATIC RISK ASSESSMENT OF POWER OUTAGES

(71) Applicant: Quantum Spatial Inc., Hollywood, FL (US)

(72) Inventors: William David FELLERS, Portland, OR (US); Ian Joseph BERDIE, Portland, OR (US); Brian Neil KASPER, Portland, OR (US); Jennifer Marie WHITACRE, Portland, OR (US)

(73) Assignee: Quantum Spatial Inc., Hollywood, FL (US)

(21) Appl. No.: 17/539,310

(22) Filed: Dec. 1, 2021

Related U.S. Application Data
(60) Provisional application No. 63/120,596, filed on Dec. 2, 2020.

(51) Int. Cl. G06Q 10/06; G06V 20/17; G06V 20/10; G06Q 50/06

(52) U.S. Cl. CPC G06Q 10/0635; G06Q 50/06; G06V 20/188; G06V 20/17

(57) ABSTRACT

System and methods of automatically assessing power outage risks using geospatial data are provided. For example, a computing device may obtain geospatial data for an area, and may generate classification data based on classifying a plurality of points of the geospatial data. The computing device may also generate a plurality of segments of the area based on the classification data, where each of the plurality of segments includes a subset of the plurality of points. The computing device may also determine an impact value for each of the plurality of points based on the classification data. Further, the computing device may determine an attribute value for each of the plurality of segments based on the impact values of the corresponding subset of the plurality of points. In some examples, the computing device determines a risk value for a classified point based on one or more segment attribute values.

### CROSS-REFERENCE TO RELATED APPLICATIONS

This application claims priority to U.S. Provisional Application Ser. No. 63/120,596 filed on Dec. 2, 2020 and entitled “METHODS AND APPARATUS FOR AUTOMATIC RISK ASSESSMENT OF POWER OUTAGES,” the content of which is hereby incorporated by reference in its entirety.

### FIELD OF THE INVENTION

The disclosure relates generally to risk assessments and, more particularly, to automatically assessing power outage risks using geospatial data.

### BACKGROUND

Power grids provide power to consumers, such as homes and businesses. For example, a power grid may include several sections, where each section includes utility poles and corresponding transformers that deliver power to one or more consumers. Sometimes, however, a power grid may experience an outage, where the power grid fails to provide power to one or more sections. As an example, power outages may be caused by tree failure, such as when a tree falls on a power line that delivers power to one or more consumers. These power outages may cost utility companies large amounts of time and money in responding to the power outages and fixing the cause of the outage, such as by repairing or replacing downed power lines. In some examples, utility companies may attempt to mitigate future power outages by maintaining vegetation, such as by pruning the vegetation. These efforts, however, are costly, and often times such maintenance isn't performed in a timely fashion to prevent a future power outage. As such, there are opportunities to address these and other issues with current power outage mitigation processes.

### SUMMARY

The embodiments, in some examples, employ descriptive three-dimensional (3D) spatial proximity analytics of trees approximated and derived from remotely sensed geospatial data, such as light detection and ranging (LIDAR) data, along with historical outage data to assign a relative risk for every identified tree within an area.

For example, in some embodiments, a computing device receives geospatial data (e.g., LIDAR data) for an area, and applies one or more machine learning processes to classify each point of the geospatial data. The classification may classify a point as a tree, for example. The computing device also aggregates the points of geospatial data to generate segments based on application of a segmentation algorithm to the classified points, and further determines, for each point of the geospatial data, whether a tree at the point's location cold impact structure, such as power lines, if the tree fell. The computing device also determines the segments that include any geospatial points determined to impact structure. For each segment that includes geospatial points determined to impact structure, the computing device determines at least one segment attribute based on attributes of the geospatial points within a corresponding segment. The computing device then determines a risk score for each segment based on the attributes and historical outage data corresponding to each segment.

In some embodiments, a system includes a memory device, and a computing device communicatively coupled to the memory device. The computing device is configured to obtain geospatial data for an area. The computing device is also configured to generate classification data based on classifying a plurality of points of the geospatial data. Further, the computing device is configured to generate a plurality of segments of the area based on the classification data, where each of the plurality of segments includes a subset of the plurality of points. The computing device is also configured to determine an impact value for each of the plurality of points based on the classification data. The computing device is further configured to determine an attribute value for each of the plurality of segments based on the impact values of the corresponding subset of the plurality of points. The computing device is also configured to store the attribute values in the memory device.

In some embodiments, a method by a computing device includes obtaining geospatial data for an area. The method also includes generating classification data based on classifying a plurality of points of the LIDAR data. Further, the method includes generating a plurality of segments of the area based on the classification data, where each of the plurality of segments includes a subset of the plurality of points. The method also includes determining an impact value for each of the plurality of points based on the classification data. The method further includes determining an attribute value for each of the plurality of segments based on the impact values of the corresponding subset of the plurality of points. The method also includes storing the attribute values in a memory device.

In some embodiments, a non-transitory computer readable medium has instructions stored thereon. The instructions, when executed by at least one processor, cause a device to perform operations that include obtaining geospatial data for an area. The operations also include generating classification data based on classifying a plurality of points of the LIDAR data. Further, the operations include generating a plurality of segments of the area based on the classification data, where each of the plurality of segments includes a subset of the plurality of points. The operations also include determining an impact value for each of the plurality of points based on the classification data. The operations further include determining an attribute value for each of the plurality of segments based on the impact values of the corresponding subset of the plurality of points. The operations also include storing the attribute values in a memory device.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 illustrates a risk determination system, in accordance with some embodiments;

FIG. 2 illustrates a computing device, in accordance with some embodiments;

FIG. 3 illustrates portions of the risk determination system of FIG. 1, in accordance with some embodiments;

FIGS. 4A and 4B illustrate topography images with segmentation generated in accordance with some embodiments;

FIG. 5A illustrates a graph with aggregated slope values, in accordance with some embodiments;

FIG. 5B illustrates a graph with aggregated tree height values, in accordance with some embodiments;

FIG. 5C illustrates a graph with aggregated offset values, in accordance with some embodiments;

FIG. 5D illustrates a graph with aggregated region values, in accordance with some embodiments;

FIG. 6 illustrates a flowchart of an exemplary method to determine segment attribute values, in accordance with some embodiments;

FIGS. 7A and 7B illustrate flowcharts of exemplary methods to determine segment values, in accordance with some embodiments;

FIG. 8 illustrates a flowchart of an exemplary method to determine outage values, in accordance with some embodiments; and

FIG. 9 illustrates a flowchart of another exemplary method to determine risk values, in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

Among other advantages, the embodiments may allow for an earlier identification of potentially hazardous vegetation, thereby allowing a more timely servicing of the potential hazardous vegetation. For example, by identifying trees that may fall on overhead power lines in advance, utility companies may service the trees (e.g., prune them, cut them down, etc.) prior to them actually falling on the overhead wires (e.g., such as due to high winds). Additionally, in preparation for a storm, utility companies may shut power off to power lines that may be impacted by the hazardous vegetation to minimize damage that may be caused by the hazardous vegetation toppling during the storm. As such, the embodiments may reduce potential hazards, such as fire hazards caused by downed power lines. Persons of ordinary skill in the art having the benefit of these disclosures would recognize additional advantages as well.

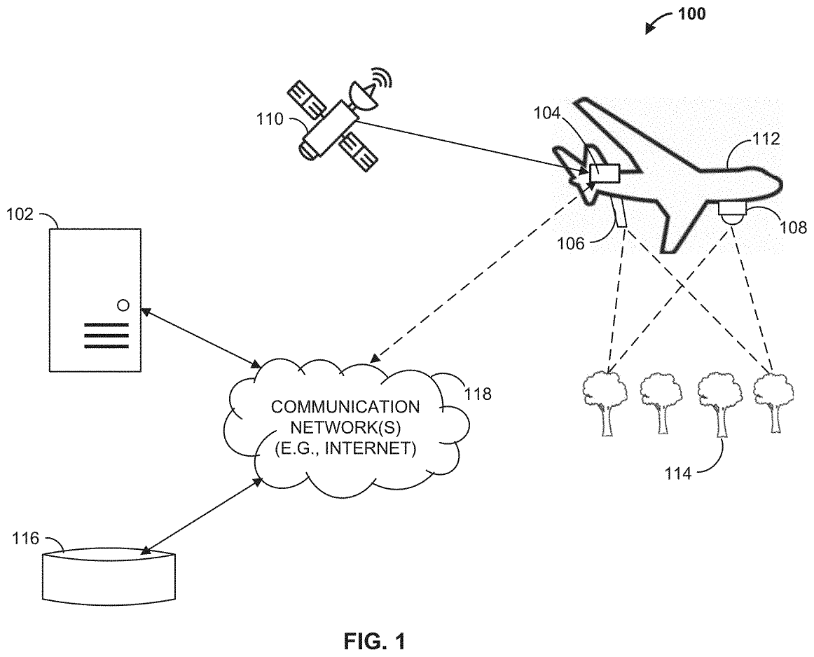

Turning to the drawings, FIG. 1 illustrates a block diagram of a risk determination system 100 that includes an aircraft 112 flying over a scene (e.g., trees) 114. Aircraft 112 includes a laser scanning system 106 (e.g., laser and corresponding LIDAR sensor), an imagery sensor 108 (e.g., camera), and a computing device 104. Laser scanning system 106 is operable to transmit a laser beam (e.g. laser pulses) to scene 114 and detect reflections with the LIDAR sensor to generate LIDAR data associated with three-dimensional (3D) measurements (e.g., x, y, z positional measurements). Imagery sensor 108 is operable to capture images of scene 114. Imagery sensor 108 may be a high resolution camera such as a charge-coupled device (CCD) camera, or any suitable camera. Although this example illustrates aircraft 112, in other examples, any other suitable collection vehicle, such as a helicopter, a car, or one or more tripods, may be employed. In addition, although a laser scanning system 106 capturing LIDAR data is illustrated in this example, systems that capture other types of geospatial data may be employed in other examples. Indeed, the embodiments described herein may be employed to operate with any suitable geospatial data.

Computing device 104 may be communicatively coupled to any suitable satellite navigation systems or any suitable positional system. In this example, computing device 104 is communicatively coupled to the Global Positioning System (GPS). For example, computing device 104 may receive latitude and longitude data from GPS satellite 110. Computing device 104 may further be communicatively coupled to an inertial navigation system (INS) of the aircraft 112. The INS system may measure roll, pitch, and heading of the laser scanning system 106.

Risk determination system 100 also includes risk determination computing device 102 and database 116. Each of computing device 104 and risk determination computing device 102 may each include any hardware or hardware and software combination that allows for processing data. For example, each can include one or more processors, one or more field-programmable gate arrays (FPGAs), one or more application-specific integrated circuits (ASICs), one or more state machines, digital circuitry, or any other suitable circuitry. For example, each of computing device 104 and risk determination computing device 102 can be a computer, a workstation, a laptop, a server, or any other suitable computing device. In addition, each can transmit and receive data over communication network 118.

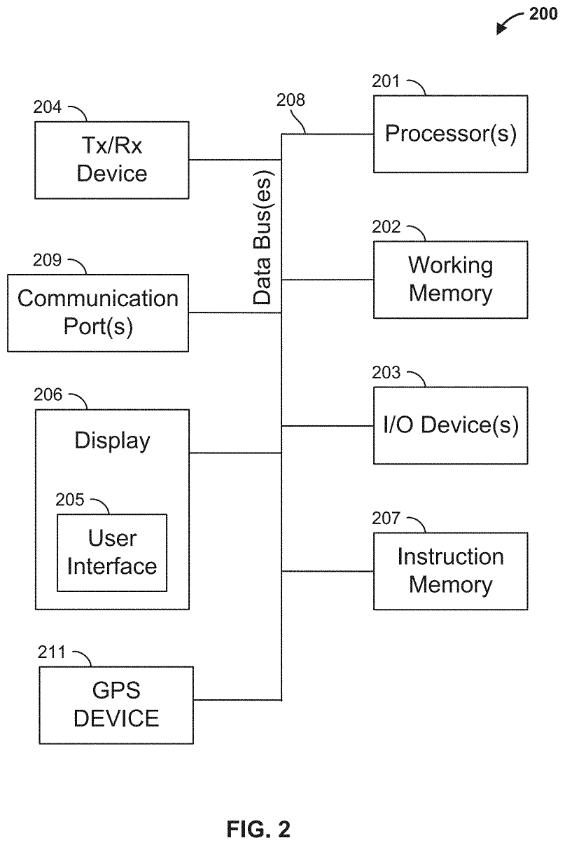

For example, FIG. 2 illustrates an exemplary computing device 200. For example, computing device 200 may be an example of computing device 104 and risk determination computing device 102. Computing device 200 can include one or more processors 201, working memory 202, one or more input/output devices 203, instruction memory 207, a transceiver 204, one or more communication ports 209, a display 206 with a user interface 205, and a global positioning system (GPS) device 211, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 201 can be configured to perform a certain function or operation by executing code, stored on instruction memory 207, embodying the function or operation. For example, processors 201 can be configured to execute code stored in instruction memory 207 to perform one or more of any function, method, or operation disclosed herein.

Additionally processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of risk determination computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as LIDAR data or image data.

Display 206 can be any suitable display, and may display user interface 205. User interfaces 205 can enable user interaction with computing device 200. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. Processor(s) 201 is operable to receive data from, or send data to, a network, such as communication network 118 of FIG. 1, via transceiver 204.

GPS device 211 may be communicatively coupled to the GPS and operable to receive position data from the GPS. For example, GPS device 211 may receive position data identifying a latitude, longitude, and altitude from a satellite (e.g., satellite 110) of the GPS. Based on the position data, computing device 200 may determine a 3-dimensional (e.g., X, Y, and Z) location.

Referring back to FIG. 1, database 116 can be a remote storage device, such as a cloud-based server, a disk (e.g., a hard disk), a memory device on another server, a networked computer, or any other suitable remote storage. Risk determination computing device 102 is operable to communicate with database 116 over communication network 118. For example, risk determination computing device 102 may store data to, or read data from, database 116. In some examples, computing device 104 is operable to communicate with database 116 over communication network 118.

Communication network 118 can be a WiFi network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

In some examples, laser scanning system 106 may scan scene 114 to generate LIDAR data, and provide the LIDAR data to computing device 104. The LIDAR data may include a plurality of points, where each point is associated with a three dimensional (3D) measurement (e.g., x, y, z measurement values). Computing device 104 may store the LIDAR data in a memory device, such as database 116. Similarly, imagery sensor 108 may take images of scene 114, and may provide the images to computing device 104. Computing device 104 may store the images in the memory device.

Risk determination computing device 102 may obtain LIDAR data for an area, such as for scene 114, and may apply one or more machine learning processes (e.g., algorithms) to the obtained LIDAR data to classify each point as, for example, vegetation, or not vegetation (e.g., as a tree or not a tree). The machine learning process may be, for example, a supervised classification process, such as a binary classification process.

Further, risk determination computing device 102 generates segments (e.g., tree segments) based on the obtained LIDAR data for the area. Each segment may include one or more points of the LIDAR data. Risk determination computing device 102 may generate the segments based on applying a segmentation algorithm to the LIDAR data. Each segment includes points corresponding to a subset of the area. For example, each segment may be a polygon that defines the subset of the area.

Risk determination computing device 102 may perform an impact analysis for each point. For example, risk determination computing device 102 may determine, for each point, whether a tree, if located at the point, can impact a structure, such as an overhead power line, if the tree toppled. To make the determination, risk determination computing device 102 may obtain structure location data from database 116, where the structure location data identifies one or more locations (e.g., x, y, z coordinates) of each structure. Risk determination computing device 102 may then determine a distance from a point to each structure based on the LIDAR data and the structure location data, and determine whether a tree located at the point can impact the structure if the tree fell based on the determined distance. For example, risk determination computing device 102 determines whether a tree, with a height corresponding to the point (e.g., the z coordinate value), is tall enough such that if the tree fell, it would impact the structure (e.g., the tree would fall over an overhead power line by more than a threshold amount, such as 5 feet). Risk determination computing device 102 may generate impact data (e.g., impact values) identifying whether a tree located at each point would impact a structure if the tree toppled.

Risk determination computing device 102 may then determine segments that include points determined to impact structure (e.g., based on the impact data). For example, risk determination computing device 102 may determine, based on x, y coordinates of each point and of the border of each segment, any segments that include the points. Risk determination computing device 102 may generate segmentation data identifying the segments and corresponding points. In some examples, risk determination computing device 102 overlays a map of the points determined to impact structure over a map of the determined segments, and provides the overlaid maps for display.

For each segment with points, risk determination computing device 102 determines at least one attribute for the segment based on attributes of the LIDAR points within the segment. For example, risk determination computing device 102 may determine a segment attribute based on a corresponding “worst” attribute of all points within the segment. In some examples, a segment attribute is a height attribute based on the point with a greatest height (e.g., as determine by the “z” coordinate values). For example, risk determination computing device 102 determines the segment attribute to be the greatest height among all the points within the segment, and assigns that height to all points within the segment (e.g., the height segment attribute).

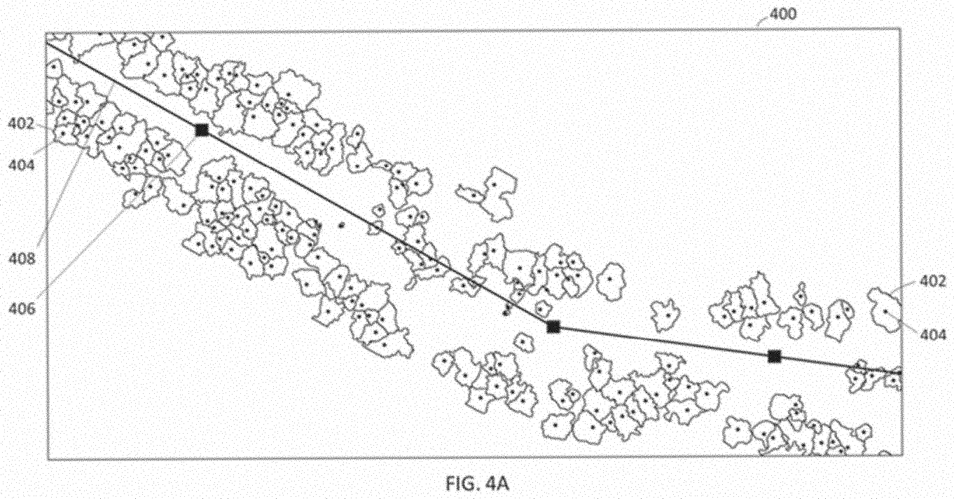

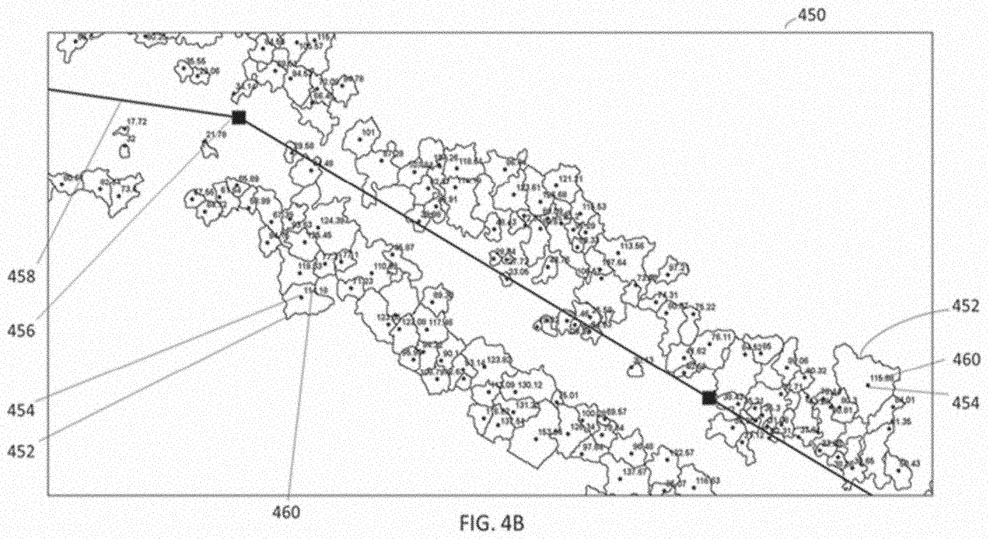

For example, FIG. 4A illustrates a topography image 400 that includes segments 402 with determined tree top locations 404. Each tree top location 404 may be a location of the tree within the segment 402 with the greatest height. Topography image 400 also illustrates utility towers 406, and power centerlines 408. Risk determination computing device 102 may determine power centerlines 408 based on a centerline of alignment between two utility towers 406. In some examples, a segment is not generated when no points are associated with a height above a minimum amount (e.g., 3 feet).

FIG. 4B illustrates a topography image 450 that includes segments 452 with determined tree top locations 454 as well as the computed greatest height 460. Each tree top location 454 may be a location of the tree within the segment 452 with the greatest height 460. The greatest height 460 may be computed directly from the LIDAR data for each segment 452. Topography image 450 also illustrates utility towers 456, and power centerlines 458. Risk determination computing device 102 may determine power centerlines 458 based on a centerline of alignment between two utility towers 456.

Referring back to FIG. 1, in some examples, a segment attribute is a closest distance from the closest point to a structure (e.g., the closest distance segment attribute). For example, risk determination computing device 102 determines a segment structure distance to be the closest distance from all points of the segment to the closest structure, and assigns that structure distance to the segment. In some examples, risk determination computing device 102 assigns the largest height attribute, and the closest distance from a point to the closest structure, to each segment. Additionally, risk determination computing device 102 determines the largest potential overstrike distance from all segment points to a closest structure, and assigns the largest potential overstrike distance to each segment.

Risk Score

Risk determination computing device 102 may then determine, for each tree segment, a risk score. The risk score may be based on determining one or more of an outage score, and a descriptive score. In some examples, the risk score is based on the outage score. In some examples, the risk score is based on the descriptive score. In some examples, the risk score is based on at least the outage score and the descriptive score. For example, the risk score may be determined according to the equation below:

Risk Score=(Outage Score+Descriptive Score)/n; (eq. 1)
where n is configurable, and may be based on the number of components to the Risk Score. (e.g., n=2).

In some examples, the Outage Score is normalized to a range of values, such as to between 1 and 100 (e.g., where 1 represents the lowest possible outage score, and 100 represents the highest possible outage score). The Outage Score may be normalized to a range for which the Descriptive Score falls within, for example. In some examples, the Outage Score and the Descriptive Score are weighted differently. For example, the Outage Score may be multiplied by a value α, and the Descriptive Score is multiplied by a value of 1−α, where α is a value between 0 and 1, inclusive.

Risk determination computing device 102 may store the generated Risk Scores in a database, such as in database 116. In some examples, risk determination computing device 102 may transmit the risk scores, such as to a computing device. In some examples, risk determination computing device 102 generates and transmits a communication (e.g., text, email, etc.) when a Risk Score is above a predetermined threshold (e.g., 75 on a scale of 0 to 100). The communication may be sent to an associate of a utility company responsible maintaining power lines, for example. In some examples, risk determination computing device 102 provides the Risk Scores for display.

### Outage Score

As noted above, to generate the Risk Scores, risk determination computing device 102 determines an Outage Score. Each Outage Score may be determined based on one or more components. For example, the Outage Score may be computed according to the equation below:

Outage Score=Slope Score+Offset Score+Height Score+Region Score; (eq. 2)

In some examples, each of the Slope Score, Offset Score, Tree Height Score, and Region Score are weighted based on a preconfigured value. The preconfigured values may be provided by a user and stored in database 116, for example.

The Outage Score may be determined based on historical outage data that may be maintained in database 116. The historical outage data may have been recorded by a utility company when servicing various locations, and stored within database 116, for example. The historical outage data may identify, for each of a plurality of trees, one or more features, such as a slope, a height, an offset, and a zone. Moreover, the historical outage data may identify a frequency of each feature over an entire outage database, and a relative frequency of the feature for failure for each of a plurality of causative factors (e.g., wind).

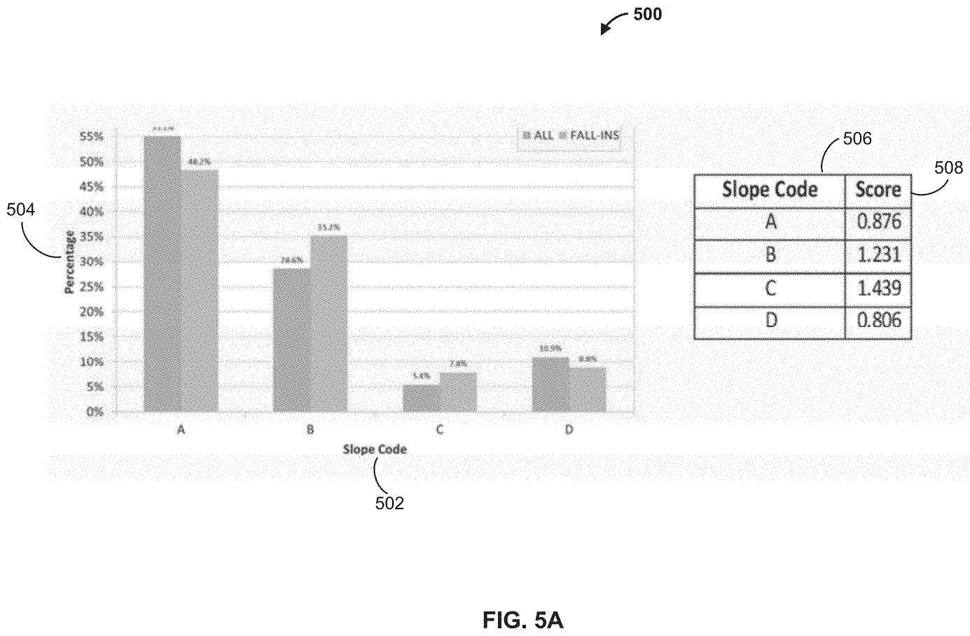

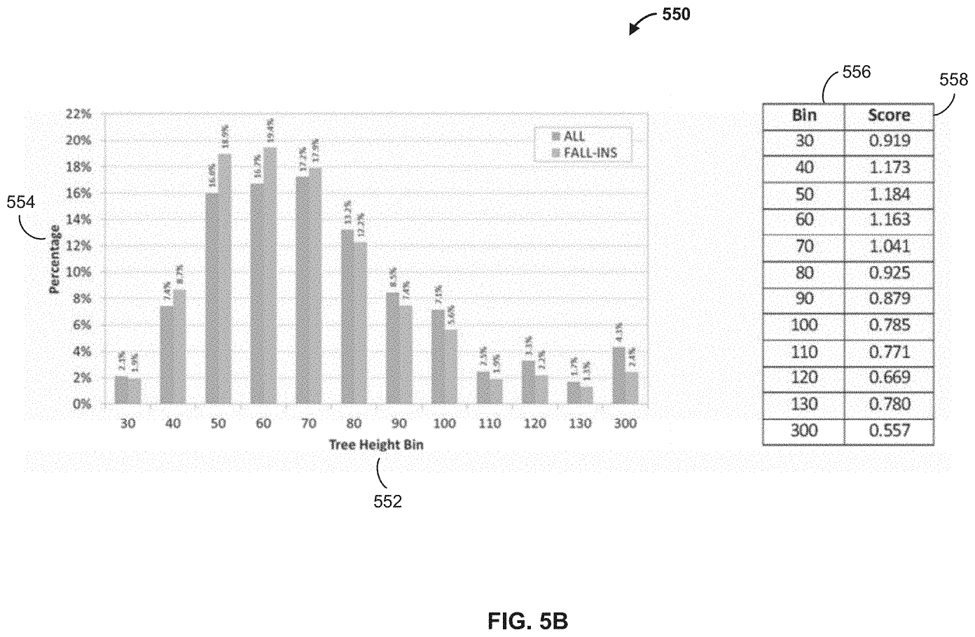

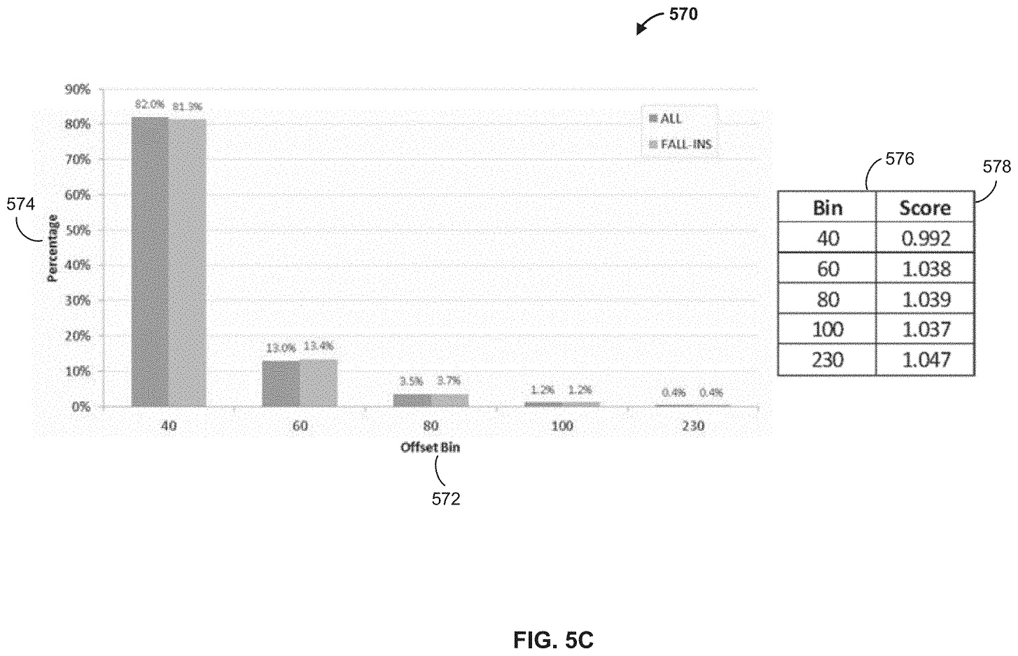

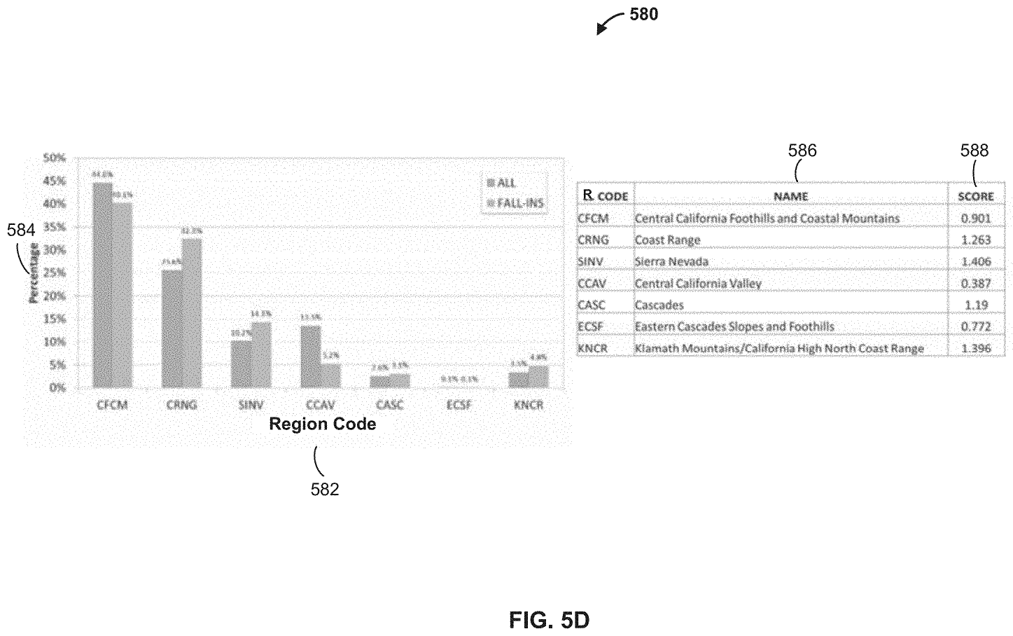

The Slope Score may be based on the slope of each tree, such as a number of degrees of a surface that the tree is located on. For example, trees on steeper slopes may tend to fall more often than trees on more level surfaces. Each tree may be assigned a score based on its slope. For example, FIG. 5A illustrates a graph 500 based on aggregated slope values. Graph 500 includes slope codes 502 on the horizontal axis. Each slope code 502 may be associated with a slope range. For example, trees with a slope of less than 5° are assigned to slope code “A.” Trees with a slope greater than or equal to 5° and less than 15° are assigned to slope code “B,” while trees with a slope greater than or equal to 15° and less than 45° are assigned to slope code “C.” Finally, trees with a slope of greater than or equal to 45° are assigned to slope code “D.”

Graph 500 illustrates percentage values 504 along the vertical axis. The first bar for each slope code 502 identifies a percentage of all trees in this example associated with the corresponding slope code 502, while the second bar identifies a percentage of all trees that have fallen and associated with the corresponding slope code. For example, graph 500 illustrates that while only 28.6% of all trees in this example are associated with slope code “B,” they represent 35.2% of all trees that have fallen. In comparison, 55.1% of all trees are associated with slope code “A,” but a lesser amount, 48.2%, of trees that have fallen are associated with a slope code of “A.” As such, as compared to trees associated with other slope codes, graph 500 may indicate that trees associated with slope code “B” are more likely to topple.

Graph 500 further includes a score key 506 that identifies a slope score 508 for each slope code 502. Risk determination computing device 102 may compute, based on the historical outage data, a fall-in frequency (e.g., a number of trees that fell) and a total population frequency (e.g., a total number of trees) for each slope range for each of a plurality of bins. Risk determination computing device 102 may compute slope scores 508 by dividing the fall-in frequency by the total population frequency for each bin. As an example, and assuming a fall-in frequency of 35.2 and a total population frequency of 28.6 for a particular bin, risk determination computing device 102 may determine a slope score of 1.231, which corresponds to slope code “B” in graph 500. Risk determination computing device 102 may determine, for each tree identified in the historical outage data, the Slope Score based on slope score 508 of graph 500.

The Height Score is based on the height of each tree. For example, FIG. 5B illustrates a graph 550 that displays height bins 552 along the horizontal axis and percentage values 554 along the vertical axis. The height bins 552 identify trees with a height within a particular range. For example, each tree height bin may represent trees up to a maximum height, such as 30 feet, 40 feet, up to 300 feet.

The first bar associated with each height bin 552 identifies a percentage of all trees in this example with a maximum tree height corresponding to each height bin 552, while the second bar identifies a percentage of all trees that have fallen and are associated with the corresponding height bin 552. For example, graph 550 illustrates that while only 2.1% of all trees in this example are associated with height bin “30,” they represent 1.9% of all trees that have fallen. In comparison, 16.7% of all trees are associated with tree height bin “60,” but a greater amount, 19.4%, of trees that have fallen are associated with the same tree height bin. As such, graph 550 may indicate that trees associated with tree height bin 60 are more likely to topple than trees associated with height bin “30.”

Graph 550 further includes a score key 556 that identifies a height score 558 for each height bin 552. Risk determination computing device 102 may compute height scores 558 by dividing a fall-in frequency by a total population frequency (e.g., based on corresponding height ranges) for each bin. Risk determination computing device 102 may determine the Height Score based on height score 558 of graph 550, for example.

The Offset Score indicates an offset from an alignment of each tree. The offset may be a distance from the closest vegetation (e.g., tree) classified lidar point within a segment to a lidar derived wire. For example, FIG. 5C illustrates a graph 570 that displays offset bins 572 along the horizontal axis and percentage values 574 along the vertical axis. The offset bins 572 identify trees with an offset within a particular range. For example, each offset bin may represent trees up to a maximum amount, such as 40 feet, 60 feet, up to 230 feet.

The first bar associated with each offset bin 572 identifies a percentage of all trees in this example with a maximum offset corresponding to each offset bin 572, while the second bar identifies a percentage of all trees that have fallen and are associated with the corresponding offset bin 572. For example, graph 570 illustrates that only 1.2% of all trees in this example are associated with offset bin “100,” and represent 1.2% of all trees that have fallen. In comparison, 82.0% of all trees are associated with offset bin “40,” while 81.3% of trees that have fallen are associated with the same offset bin. As such, graph 570 may indicate that offset from alignment isn't as much of a major factor in determining fall risk, at least in this example.

Graph 570 further includes a score key 576 that identifies an offset score 578 for each offset bin 572. Risk determination computing device 102 may compute offset scores 578 by dividing a fall-in frequency by a total population frequency (e.g., based on corresponding offset ranges) for each bin Risk determination computing device 102 may determine the Offset Score based on offset score 578 of graph 570, for example.

The Region Score is based on a region that each tree is located within. The region may be, for example, a region of land, a zip code, a town or city, defined by latitude and longitude coordinates, or any other suitable region. For example, FIG. 5D illustrates a graph 580 that displays region codes 582 along the horizontal axis and percentage values 584 along the vertical axis. The region codes 582 identify trees within a particular region. Region key 586 defines the region codes 582. For example, region code “CCAV” pertains to the Central California Valley region.

The first bar associated with each region code 582 identifies a percentage of all trees in this example that reside within the corresponding region code 582, while the second bar identifies a percentage of all trees that have fallen that reside within the corresponding region code 582. For example, graph 580 illustrates that while only 10.2% of all trees in this example reside within the “SINV” region, 14.3% of all trees that have fallen reside in the region. In comparison, 11.5% of all trees reside in the “CCAV” region, but only 5.2% of all trees that have fallen reside in that region. As such, graph 580 may indicate that trees in certain regions may tend to fall more often than trees in other regions.

Region key 556 also identifies a region score 588 for each region code 582. Risk determination computing device 102 may compute region scores 588 by dividing a fall-in frequency by a total population frequency (e.g., based on corresponding regions) for each bin Risk determination computing device 102 may determine the Region Score based on region score 588 of graph 580, for example.

In addition to, or instead of, the above metrics, the Outage Score may be computed based on other metrics as well. For example, the Outage Score may be computed based on one or more of a Tree Species, Tree Diameter at Breast Height (DBH), Isolated Tree, Tree Lean, Soil type, Plant Community, Live Crown Ratio, Tree Taper, Ridgetop or Valley Trees, or Impacts of Tree Failure. Tree Species may identify a genus and/or species of an individual tree. Tree Diameter at Breast Height (DBH) may identify a measurement of tree trunk diameter taken at a distance above ground (e.g., such as approximately 4.5 ft (1.37 m) above ground). Isolated Tree may identify trees determined to be isolated either horizontally (e.g., no near adjacent neighbors) or vertically (e.g., focus tree height extends significantly higher than adjacent trees). Tree Lean may identify a degree to which the main trunk of the tree leans from a vertical direction, and direction of the lean in proximity to a utility infrastructure. Soil Type may identify the surface mineral and/or organic layer of the earth where a tree is located, such as soil that has experienced some degree of physical, biological, and chemical weathering. Plant Community may identify a collection or association of plant species within a designated geographical unit, which may form a relatively uniform patch, and may be distinguishable from neighboring patches of different vegetation types. Live Crown Ratio may identify a percent of total tree height that supports live foliage. Tree Taper may identify a degree to which a tree's stem or bole decreases in diameter as a function of height above ground. Ridgetop or Valley Trees may identify a measurement of the spatial proximity of a tree to an identified ridgetop or valley in the landscape. Impacts of Tree Failure may identify, assuming a tree fell into utility infrastructure, “impact” metrics that describe the degree of effects due to the falling. The effects may include impact to someone (e.g., residents) or something (e.g., power lines). The effects may include, for example, any impact related to infrastructure and/or personal safety, potential fire ignition impact, and impacts related to electric reliability.

Referring back to FIG. 1, risk determination computing device 102 may determine the Outage Score for each of the plurality of trees based on the corresponding Slope Score, Offset Score, Tree Height Score, and Region Score computed for each tree, and may store the Outage Scores in database 116.

### Descriptive Score

As noted above, to generate the Risk Scores, risk determination computing device 102 may also determines a Descriptive Score. Each Descriptive Score may be determined based on one or more components. For example, risk determination computing device 102 may determine the Descriptive Scores according to the equation below:

Descriptive Score=(Fall Distance Score+Front Row Score+Slope to Wire Score)/n; (eq. 3);
where n is configurable, and may be based on the number of components to the Risk Score. (e.g., n=3)

Each of the Fall Distance Score, Front Row Score, and Slope to Wire Score may be determined based on the generated segments and corresponding LIDAR data (e.g., points) and segment attributes. In some examples, each of the Fall Distance Score, Front Row Score, and Slope to Wire Score are weighted based on a preconfigured value. The preconfigured values may be provided by a user and stored in database 116, for example.

The Fall Distance Score may be based on a determined amount of tree height that may contact a structure, such as a power line. For example, for each point classified as a tree of each segment, risk determination computing device 102 may determine, based on its segment attribute of the point with the greatest height (e.g., height segment attribute), a portion of the height that, if the tree fell, would fall over the closest structure to the point. The distance to the closest structure may be identified by the corresponding closest distance segment attribute. For example, risk determination computing device 102 may subtract the closest distance segment attribute from the tree height segment attribute to determine the amount (e.g., length) of the tree that would contact or fall over the structure. In some examples, the Fall Distance Score is a percentage of the tree height that would strike or go over the structure if the tree toppled.

The Front Row Score may indicate a number of potential paths that a tree located within a segment has to an impact structure based on an analysis of the proximity to the structure. For example, risk determination computing device 102 may determine, in increments (e.g., 1° increments), whether the height segment attribute of the segment is large enough (e.g., long enough) to reach the closest structure. For example, risk determination computing device 102 may determine whether, at 0° to the closest structure (e.g., closest path to the closest structure), the height segment attribute of the segment is at least as large as the closest distance segment attribute. If the height segment attribute of the segment is at least as large as the closest distance segment attribute, then the closest structure may be impacted. Otherwise, if the height segment attribute of the segment is not at least as large as the closest distance segment attribute, the closest structure may not be impacted. Risk determination computing device 102 may then determine the same, but instead if the tree fell at 1° to the closest structure. Risk determination computing device 102 may apply any triangulation algorithms to determine whether impact would results. Similarly, risk determination computing device 102 may perform a similar analysis until 90°, as well as to −90°, for a total analysis covering 180° of potential topple paths.

In some examples, risk determination computing device 102 determines whether other structure (e.g., vegetation) may block potential paths to the impact structure. For example, if analyzing a first segment and a second segment is in between the first segment and the impact structure, the path to the impact structure may be considered blocked. In some examples, the path is considered blocked only if the second segment has a height segment attribute that is more than a predetermined amount (e.g., 50%) of the height segment attribute of the first segment.

In some examples, the Front Row Score is computed as a value of 1 to 100, where a value of 1 indicates no unblocked paths (e.g., all paths blocked or not structure not reachable if tree fell along a path), a value of 100 indicates 179 or more unblocked paths, and otherwise the value is computed according to the equation below.

Front Row Score=((number of unblocked paths/179)*99)+1; (eq. 4)

The Slope to Wire Score may indicate a slope (e.g., in degrees) from an elevation of a point classified as a tree to an elevation of a structure, such as the closest structure to a segment. For example, the Slope to Wire Score may measure the degree to which a tree located at the point is upslope or downslope of the structure, such as a power line. The Slope to Wire Score may be computed based on ground classified LiDAR points, a treetop point (e.g., from the segmentation process), and a collection of densely spaced points representing the centerline of alignment between two utility towers (e.g., power centerlines 408 between utility towers 406). The ground classified points are utilized to generate a ground elevation model where every location on the model represents an xyz elevation of the ground surface. A nearest centerline point to the treetop point (e.g., in xy space) is determined. The treetop points and centerline points are then projected vertically downward to the ground elevation model and the slope of the line connecting the two points (e.g., in xyz space) is computed. Negative slopes may be downslope, and positive slopes may be upslope, to the corresponding centerline point.

In some examples, risk determination computing device 102 may determine a tree's slope based on the height segment attribute of the segment, and a height coordinate (e.g., “z” coordinate) of the structure, as defined by LIDAR data for the structure. For example, risk determination computing device 102 may determine a difference between the height segment attribute of the segment and the height of the structure, and divide the difference by the closest distance segment attribute for the segment. In some examples, risk determination computing device 102 may normalize the result to degrees (e.g., 0 to 360°), such as by multiplying the result by 360.

In some examples, the Slope to Wire Score is based on the determined slope. For example, if the slope is less than to −45° (a negative value may indicate downslope, whereas a positive value may indicate upslope), the Slope to Wire Score is 1. If the slope is greater than or equal to 45°, the Slope to Wire Score is 100. Otherwise, the Slope to Wire Score is determined according to the equation below.

Slope to Wire Score=(((slope+45)/90)*99)+1; (eq. 5)

Risk determination computing device 102 may then determine the Descriptive Score for each segment based on the corresponding Fall Distance Score, Front Row Score, and Slope to Wire Score, as described herein, and may store the Descriptive Scores in database 116.

### Risk Score, Cont

To determine the Risk Scores (e.g., per eq. 1), risk determination computing device 102 may determine, for each of the plurality of trees identified by the Outage Scores, a corresponding segment. For example, risk determination computing device 102 may determine a location of each tree (e.g., based on the historical outage data for each tree), and determine a segment that the tree resides within (e.g., based on the LIDAR data corresponding to each segment). Risk determination computing device 102 may then compute a Risk Score for each tree based on the Outage Score for the tree, and the Descriptive Score for the corresponding segment.

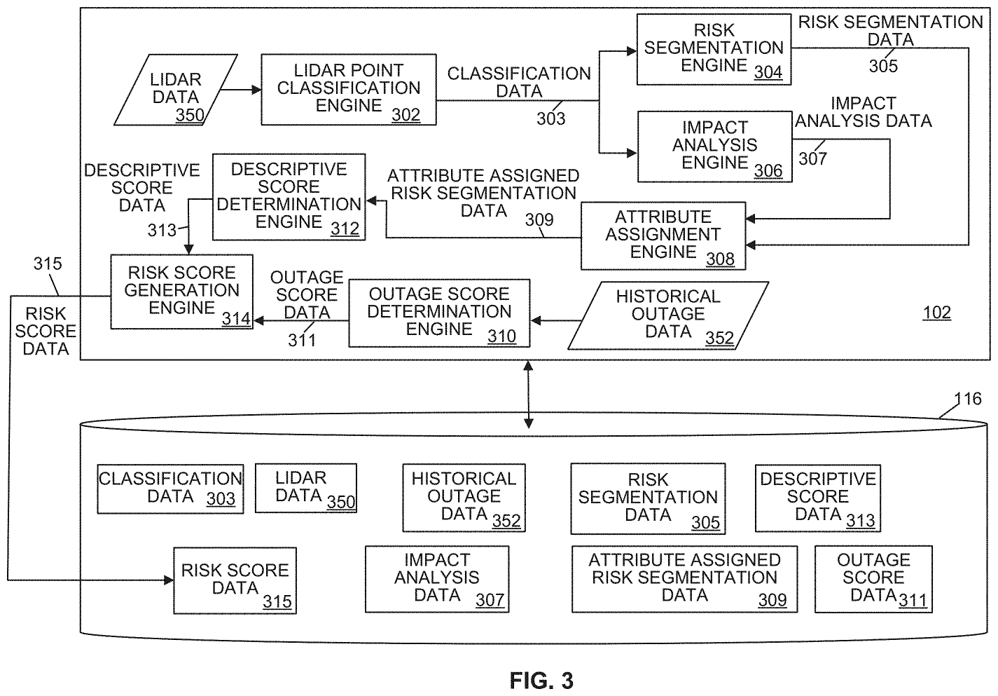

FIG. 3 illustrates exemplary portions of the risk determination system 100 of FIG. 1. In this example, risk determination computing device 102 includes lidar point classification engine 302, risk segmentation engine 304, impact analysis engine 306, attribute assignment engine 308, outage score determination engine 310, descriptive score determination engine 312, and risk score generation engine 314. In some examples, one or more of lidar point classification engine 302, risk segmentation engine 304, impact analysis engine 306, attribute assignment engine 308, outage score determination engine 310, descriptive score determination engine 312, and risk score generation engine 314 may be implemented hardware. In some examples, one or more of lidar point classification engine 302, risk segmentation engine 304, impact analysis engine 306, attribute assignment engine 308, outage score determination engine 310, descriptive score determination engine 312, and risk score generation engine 314 may be implemented as an executable program maintained in a tangible, non-transitory memory, such as instruction memory 207 of FIG. 2, that may be executed by one or processors, such as processor 201 of FIG. 2.

In this example, lidar point classification engine 302 obtains lidar data 350 from database 116. The lidar data 350 may correspond to an area, such as a particular region, for example. Lidar point classification engine 302 may apply a classifier, such as a binary classifier, to the lidar data 350 to generate classification data 303. The classification data 303 may classify each point of the lidar data 350 as a tree, or as no tree, for example. Risk segmentation engine 304 may receive the classification data 303 from lidar point classification engine 302 and apply a segmentation algorithm to the classification data 303 to generate risk segmentation data 305 identifying and characterizing segments, such as polygons including a subset of the points of the lidar data 350.

Impact analysis engine 306 may also receive the classification data 303 from lidar point classification engine 302, and may generate impact analysis data 307 identifying an impact value for each point classified as a tree. For example, impact analysis engine 306 may determine whether a point classified as a tree is close enough to a structure (e.g., power line) that, if the tree fell, it would impact the structure.

Attribute assignment engine 308 receives the risk segmentation data 305 and the impact analysis data 307, and determines at least one attribute for the segment. For example, attribute assignment engine 308 may determine a height segment attribute for each segment defined by risk segmentation data 305 based on risk segmentation data 305 for the points corresponding to the segment. In some examples, attribute assignment engine 308 also determines a closest distance segment attribute for each segment based on impact analysis data 307 for the points corresponding to each segment. Attribute assignment engine 308 may generate attribute assigned risk segmentation data 309 identifying the risk segmentation data 305 and the segment attributes generated for each segment.

Descriptive score determination engine 312 may generate descriptive score data 313 identifying a Descriptive Score for each segment. Descriptive score determination engine 312 may generate descriptive score data 313 based on segment attributes identified by attribute assigned risk segmentation data 309 received from attribute assignment engine 308. For example, descriptive score determination engine 312 may determine a Fall Distance Score, a Front Row Score, and a Slope to Wire Score for each segment, and determine the Descriptive Score for the segment based on the corresponding Fall Distance Score, Front Row Score, and Slope to Wire Score (e.g., in accordance with equation 3). Descriptive score determination engine 312 transmit the descriptive score data 313 to risk score generation engine 314.

Outage score determination engine 310 may obtain historical outage data 352 from database 116. Historical outage data 352 may identify, for each of a plurality of trees of the area, a Slope Score, such as slope score 508, a Height Score, such as height score 558, an Offset Score, such as offset score 578, and a Region Score, such as region score 588. In some examples, risk determination computing device 102 computes the slope scores, height scores, offset scores, and region scores based on information provided by utility workers when servicing power lines. Outage score determination engine 310 may determine an Outage Score for each of the plurality of trees based on the corresponding Slope Score, Offset Score, Height Score, and Region Score for each tree (e.g., in accordance with equation 2).

Risk score generation engine 314 may obtain descriptive score data 313 from descriptive score determination engine 312, and outage score data 311 from outage score determination engine 310. Further, risk score generation engine 314 may determine Risk Scores based on the Descriptive Scores identified by the descriptive score data 313 and the Outage Scores identified by the outage score data 311 (e.g., in accordance with equation 1). For example, Outage Score, risk score generation engine 314 may determine a corresponding Descriptive Score based on a location of the tree corresponding to the Outage Score and the location of the segment corresponding to the Descriptive Score. Risk score generation engine 314 may determine a Risk Score based on the Outage Score and the corresponding Descriptive Score. Risk score generation engine 314 may store the generated Risk Scores in database 116.

In some examples, risk determination computing device 102 transmits the Risk Scores to another computing device, such as to a computing device of a utility company. The utility company may then service, or schedule to service, trees with corresponding Risk Scores above a predetermined threshold (e.g., 75 on a 0 to 100 scale).

In one embodiment, the risk score may be based directly on determining a descriptive score. For example, the risk score may be determined according to the equation below:

Risk Score=Descriptive Score; (eq. 6)

In this embodiment, risk determination computing device 102 may determine the Descriptive Scores based on a Fall Distance Score, Front Row Score, Slope to Wire Score, and a Tree Exposure. For example, risk determination computing device 102 may determine the Descriptive Scores according to the equation below:

Descriptive Score=(Fall Distance Score*w1+Front Row Score*w2+Slope to Wire Score*w3+Tree Exposure*w4); (eq. 7)
where w1, w2, w3, and w4 are individually calculated weights based on user input.

Each of the Fall Distance Score, Front Row Score, Tree Exposure Score, and Slope to Wire Score may be determined based on the generated segments and corresponding LIDAR data (e.g., points) and segment attributes. In some examples, each of the Fall Distance Score, Front Row Score, Tree Exposure Score, and Slope to Wire Score are weighted (e.g., w1, w2,w3, and w4) based on a preconfigured value. The preconfigured values may be provided by a user and stored in database 116, for example.

The Fall Distance Score may be based on a determined amount of tree height that may contact a structure, such as a power line as described above.

The Front Row Score may indicate a number of potential paths that a tree located within a segment has to an impact structure based on an analysis of the proximity to the structure and the potential for other structures (e.g., vegetation) to block the paths, as described above.

The Slope to Wire Score may indicate a slope (e.g., in degrees) from an elevation of a point classified as a tree to an elevation of a structure, such as the closest structure to a segment, as described above.

The Tree Exposure Score may indicate the potential vertical exposure of an individually identified tree to impacts from wind. For one example, the Tree Exposure Score could mimic a measurement of the canopy class for each tree (e.g., the percentage the focus tree height is above or below the average tree height in a user defined area around the focus tree) using the tree heights identified within a segment. For another example, the Tree Exposure Score could compare the tree height within a focus segment to the highest appropriately classified LiDAR points from multiple measurements in a user defined radius around the focus tree segment. The Tree Exposure Score could be an additive of the inclination angles calculated for each measurement using the height of the focus tree segment to the height of the highest appropriately classified LiDAR point along each measurement path.

To finalize each of the Fall Distance Score, Front Row Score, Slope to Wire Score, and Tree Exposure Score, an analytical methodology, termed the Frequency Ratio Model, could be used. Frequency ratio is a bivariate statistical method that derives correlation between historical tree failures and each potential causative factor and is defined as the ratio of the relative frequency of a feature over the entire failure database and the relative frequency of the feature for failure for each causative factor.

Each of the Fall Distance Score, Front Row Score, Slope to Wire Score, and Tree Exposure Score, may be determined based on historical tree failure data that may be maintained in database 116. The historical data may have been recorded by a utility company when servicing various locations, and stored within database 116, for example. The historic location data may then be matched to historic LiDAR datasets covering the same area and individual segments could be identified as the trees that eventually failed. Moreover, the historical outage data may identify a frequency of each feature over an entire failure database, and a relative frequency of the feature for failure for each of a plurality of causative factors.

To construct the frequency ratio model separately for each of the Fall Distance Score, Front Row Score, Slope to Wire Score, and Tree Exposure Score, a histogram of bins could be created that calculates the counts of occurrences in each bin (e.g. the total number of trees with a slope to wire between 10-20 degrees, the total number between 20-30, etc. . . . ). The histograms are created with the same bin schema for both the historic tree failures from the historic database and for the total population of tree segments derived from the point cloud database. The frequency ratio (FR) is defined as the ratio (per bin) of the relative frequency (RF) of a feature over the population and the relative frequency of the feature over the failure trees for each causative factor using the equation:

FR=RF(Failure Trees)/RF(All Trees); (eq. 8)

Weights could be calculated for each of the Fall Distance Score, Front Row Score, Slope to Wire Score, and Tree Exposure Score, using the equations:

R(x)=FR(max)−FR(min) (eq. 9)
where R(x) is the range, and FR(max) and FR(min) are the maximum and minimum, respectively, frequency ratio values per score.

W=R(x)/R(xmin) (eq. 10)
where W is the weight per score, R(x) is the range per score, and R(x min) is the minimum range across all scores.

For each of the Fall Distance Score, Front Row Score, Slope to Wire Score, and Tree Exposure Score, the frequency ratios per bin could be normalized, such as normalized to values between 1 and 100, inclusively.

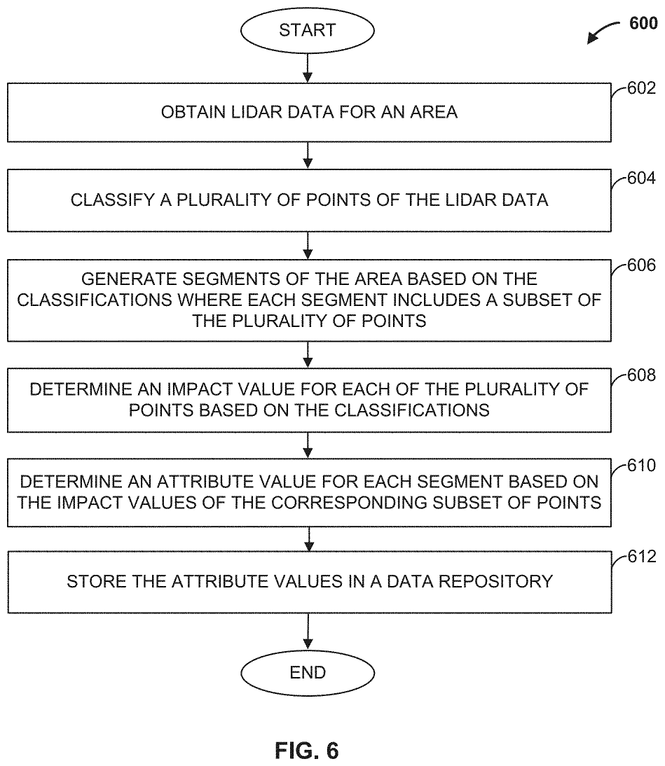

FIG. 6 illustrates a flowchart of an exemplary method 600 that can be carried out by a computing device such as, for example, risk determination computing device 102. Beginning at step 602, the computing device obtains LIDAR data for an area. The LIDAR data may be stored in a database, such as database 116. At step 604, the computing device classifies a plurality of points of the LIDAR data. For example, the computing device may apply a binary classification model to the lidar to classify each point as a tree, or as not a tree.

Proceeding to step 606, the computing device generates segments based on the classifications, where each segment includes a subset of the plurality of points of the area. For example, each segment may identify a polygon of LIDAR data. The computing device may generate the segments based on applying a segmentation algorithm to the classified points.

At step 608, an impact value is determined for each of the plurality of points based on the classifications. For example, the computing device may determine whether a tree, with a height corresponding to each point, is tall enough such that if the tree fell, it would impact a structure. The impact value identifies whether the tree located at each point would impact the structure if the tree toppled.

Proceeding to step 610, the computing device determines an attribute value for each segment based on the impact values of the corresponding subset of points for each segment. For example, the computing device may determine a greatest height among all the points within the segment, and assigns that height to all points within the segment (e.g., the height segment attribute). At step 612, the computing device stores the attribute values in a database, such as database 116. The method then ends.

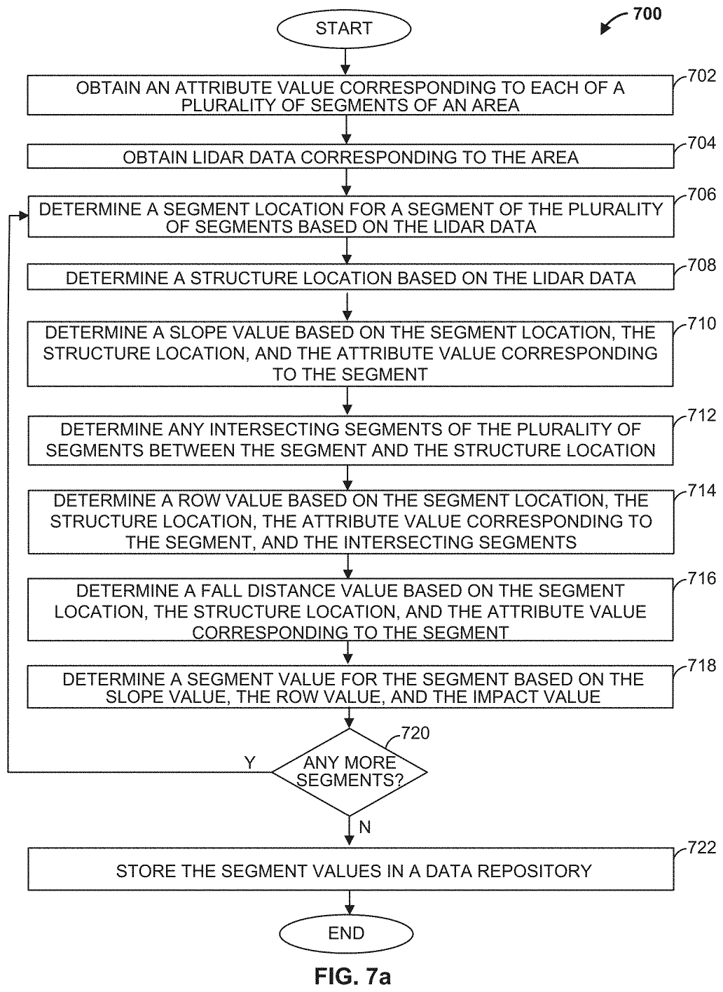

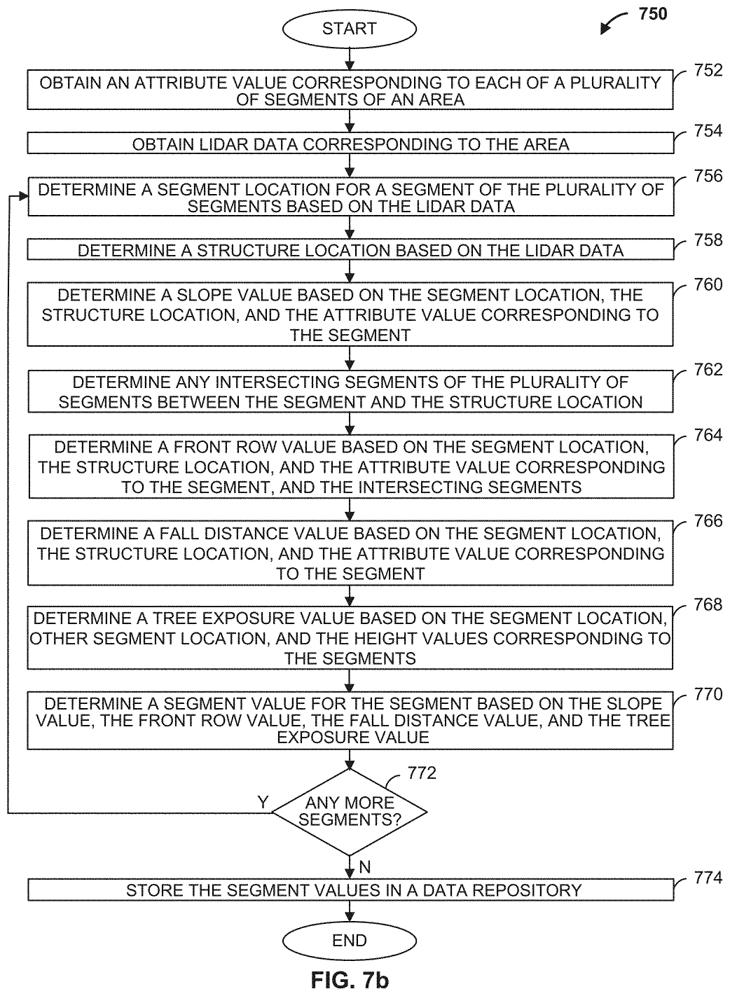

FIG. 7 illustrates a flowchart of an exemplary method 700 that can be carried out by a computing device such as, for example, risk determination computing device 102. Beginning at step 702, an attribute value corresponding to each of a plurality of segments of an area is obtained. For example, the attribute values may be ones determined in accordance with the method of FIG. 6, and the computing device may obtain the attribute values from database 116. The attribute value may be a height segment attribute. At step 704, LIDAR data corresponding to the area is obtained. For example, the computing device may obtain the LIDAR data from database 116.

At step 706, a segment location for a segment of the plurality of segments is determined based on the LIDAR data. For example, the computing device may determine x, y, z coordinate boundaries of the segment. Further, and at step 708, a structure location is determined based on the LIDAR data. For example, the computing device may determine x, y, z coordinates of the location of a closest structure based on its corresponding LIDAR data. At step 710, a slope value is determined based on the segment location, the structure location, and the attribute value corresponding to the segment. For example, the computing device may determine a Slope to Wire Score based on the height segment attribute, the z coordinate of the structure location, and a computed distance between the segment location and the structure location.

Proceeding to step 712, a determination is made as to whether there are any intersecting segments of the plurality of segments between the segment and the structure location. For example, the computing device may determine whether any of the plurality of segments are in a path from the instant segment to the structure location. At step 714, a row value is determined based on the segment location, the structure location, the attribute value corresponding to the segment, and any intersecting segments. For example, the computing device may determine a Front Row Score, in 1° increments, based on whether there is an intersecting segment along a path from the instant segment to the structure. The computing device may make such determination at angles from −90° up to 90° with respect to a line of sight (e.g., 0°) from the instant segment to the structure.

At step 716, a fall distance value is determined based on the segment location, the structure location, and the attribute value corresponding to the segment. For example, the computing device may determine a Fall Distance Score based on the segment location (e.g., the x, y coordinates for the segment location), the structure location (e.g., the x, y coordinates for the structure location), and the height segment attribute.

Proceeding to step 718, a segment value for the segment is determined based on the slope value, the row value, and the fall distance value. For example, the computing device may generate a Descriptive Score for the segment based on the Fall Distance Score, the Front Row Score, and the Slope to Wire Score.

At step 720, the computing device determines whether there are any additional segments of the plurality of segments to process. If there are any additional segments, the method proceeds back to step 706. Otherwise, if there are no additional segments, the method proceeds to step 722. At step 722, the segment values are stored in a data repository. For example, the computing device may store the generated Descriptive Scores in database 116. The method then ends.

FIG. 7B illustrates a flowchart of an exemplary method 750 that can be carried out by a computing device such as, for example, risk determination computing device 102. Beginning at step 752, an attribute value corresponding to each of a plurality of segments of an area is obtained. For example, the attribute values may be ones determined in accordance with the method of FIG. 6, and the computing device may obtain the attribute values from database 116. The attribute value may be a height segment attribute. At step 754, LIDAR data corresponding to the area is obtained. For example, the computing device may obtain the LIDAR data from database 116.

At step 756, a segment location for a segment of the plurality of segments is determined based on the LIDAR data. For example, the computing device may determine x, y, z coordinate boundaries of the segment. Further, and at step 758, a structure location is determined based on the LIDAR data. For example, the computing device may determine x, y, z coordinates of the location of a closest structure based on its corresponding LIDAR data. At step 760, a slope value is determined based on the segment location, the structure location, and the attribute value corresponding to the segment. For example, the computing device may determine a Slope to Wire Score based on the height segment attribute, the z coordinate of the structure location, and a computed distance between the segment location and the structure location.

Proceeding to step 762, a determination is made as to whether there are any intersecting segments of the plurality of segments between the segment and the structure location. For example, the computing device may determine whether any of the plurality of segments are in a path from the instant segment to the structure location. At step 764, a row value is determined based on the segment location, the structure location, the attribute value corresponding to the segment, and any intersecting segments. For example, the computing device may determine a Front Row Score, in 1° increments, based on whether there is an intersecting segment along a path from the instant segment to the structure. The computing device may make such determination at angles from −90° up to 90° with respect to a line of sight (e.g., 0°) from the instant segment to the structure.

At step 766, a fall distance value is determined based on the segment location, the structure location, and the attribute value corresponding to the segment. For example, the computing device may determine a Fall Distance Score based on the segment location (e.g., the x, y coordinates for the segment location), the structure location (e.g., the x, y coordinates for the structure location), and the height segment attribute.

At step 768, a tree exposure value is determined based on the segment location, the other segment locations, and the height value corresponding to the segments. For one example, the tree exposure score could mimic a measurement of the canopy class for each tree (e.g., the percentage the focus tree height is above or below the average tree height in a user defined area around the focus tree) using the tree heights identified within a segment.

Proceeding to step 770, a segment value for the segment is determined based on the slope value, the row value, and the fall distance value. For example, the computing device may generate a Descriptive Score for the segment based on the Fall Distance Score, the Front Row Score, and the Slope to Wire Score.

At step 772, the computing device determines whether there are any additional segments of the plurality of segments to process. If there are any additional segments, the method proceeds back to step 756. Otherwise, if there are no additional segments, the method proceeds to step 774. At step 774, the segment values are stored in a data repository. For example, the computing device may store the generated Descriptive Scores in database 116. The method then ends.

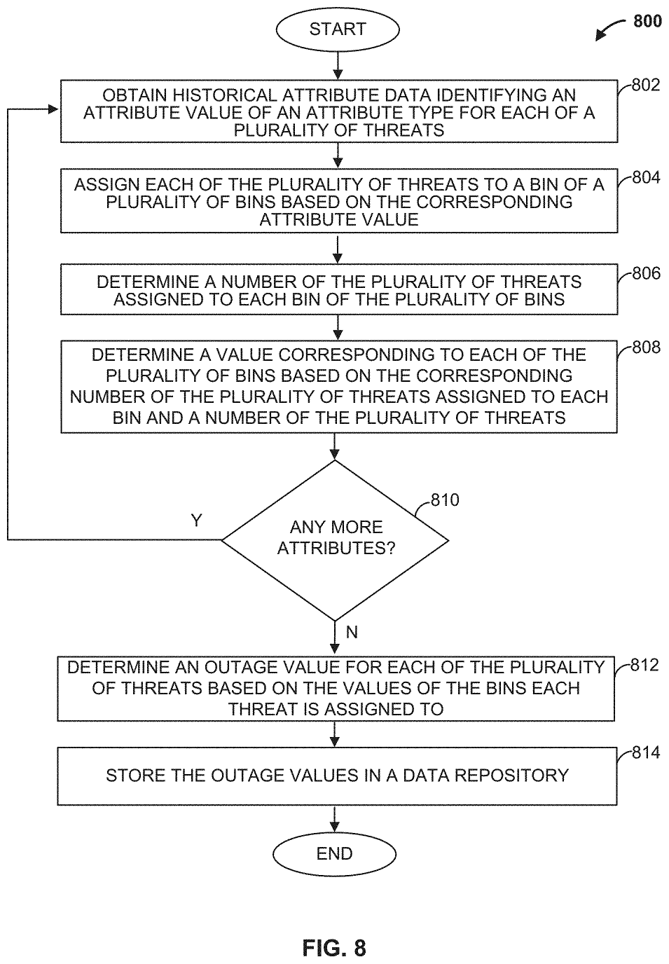

FIG. 8 illustrates a flowchart of an exemplary method 800 that can be carried out by a computing device such as, for example, risk determination computing device 102. Beginning at step 802, historical attribute data is obtained. The historical attribute data identifies an attribute value of an attribute type for each of a plurality of threats. For example, the computing device may obtain historical outage data 352 from database 116, where the historical outage data 352 identifies one or more attributes of a plurality of trees. The attributes may include, for example, slopes, tree heights, offsets, and regions.

At step 804, for a given attribute, each of the plurality of threats is assigned to a bin of a plurality of bins based on the corresponding attribute value. For example, the computing device may assign each tree a slope code 502 based on the corresponding slope value. Similarly, the computing device may assign each tree a height bin 552, an offset bin 572, or a region code 582 based on the corresponding tree height value, offset value, and region, respectively.

Proceeding to step 806, a number of the plurality of threats assigned to each of the bins are determined. At step 808, a value corresponding to each of the plurality of bins is determined. The determination is made based on the corresponding number of the plurality of threats assigned to each bin and the total number of the plurality of threats. As an example, the computing device may determine a slope score 508 based on the slope code 502 for each tree. Similarly, the computing device may determine a height score 558, an offset score 578, or a region score 588 based on the corresponding height bin 552, offset bin 572, or region code 582 for each tree.

At step 810, a determination is made as to whether there are any more attributes. For example, the computing device may determine whether values for the attributes of slopes, tree heights, offsets, and regions have been determined. If there are any additional attributes, the method proceeds back to step 802, where historical attribute data is obtained for another attribute. Otherwise, if there are no additional attributes, the method proceeds to step 812.

At step 812, an outage value for each of the plurality of threats is determined based on the values of the bins each threat is assigned to. For example, the computing device may determine an Outage Score for each of the plurality of trees based on the slope score 508, height score 558, offset score 578, and region score 588 determined for each tree. The method then proceeds to step 814, where the outage values are stored in a data repository. For example, the computing device may store the Outage Scores in database 116. The method then ends.

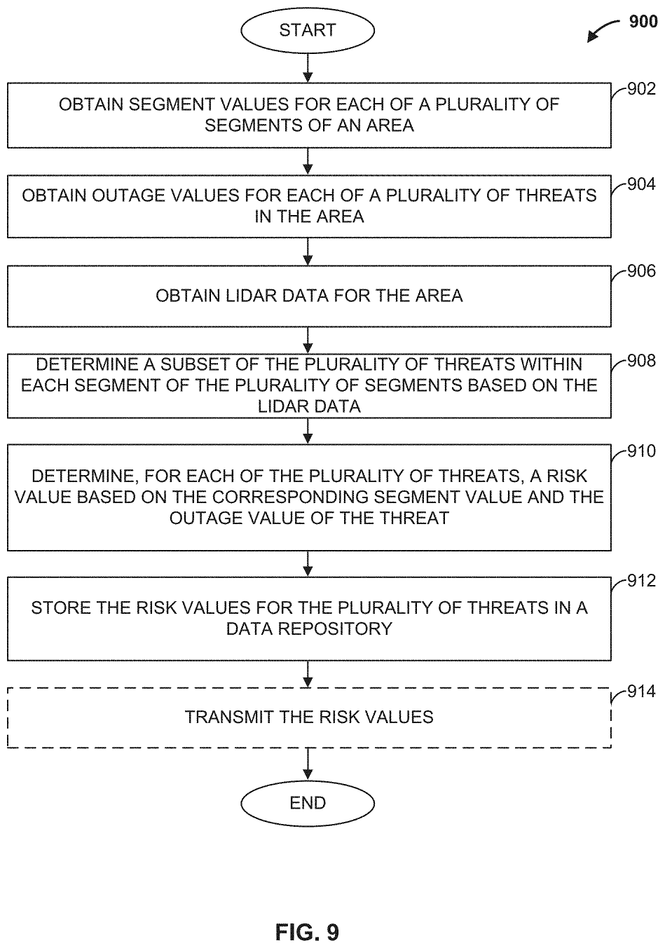

FIG. 9 illustrates a flowchart of an exemplary method 900 that can be carried out by a computing device such as, for example, risk determination computing device 102. Beginning at step 902, the computing device obtains segment values for each of a plurality of segments of an area. For example, each segment value may be a Descriptive Score associated with each segment, and may be obtained from database 116. At step 904, the computing device obtains outage values for each of a plurality of threats in the area. The threats may be trees, for example, and the outage values may be Outage Scores computed for the trees. Further, and at step 906, LIDAR data for the area is obtained.

Proceeding to step 908, a subset of the plurality of threats within each segment of the plurality of segments is determined based on the LIDAR data. For example, the computing device may determine which threats identified by the LIDAR data fall within each of the plurality of segments (e.g., based on location information).

At step 910, a risk value is determined for each of the plurality of threats. The risk value for each of the plurality of threats is determined based on the segment value of the corresponding segment and the outage value for the threat. The risk values may be, for example, Risk Scores. As an example, the computing device may determine a Risk Score for a threat based on the Descriptive Score associated with the threat's corresponding segment and the threat's Outage Score. At step 912, the risk value for each threat is stored in a data repository, such as in database 116. In some examples, at step 914, the computing device may transmit the risk values, such as to another computing device (e.g., of a utility company). The method then ends.

In some implementations, a system includes a memory device, and a computing device communicatively coupled to the memory device. The computing device is configured to obtain geospatial data for an area, and generate classification data based on classifying a plurality of points of the geospatial data. The computing device is also configured to generate a plurality of segments of the area based on the classification data, where each of the plurality of segments includes a subset of the plurality of points. Further, the computing device is configured to determine an impact value for each of the plurality of points based on the classification data. The computing device is also configured to determine an attribute value for each of the plurality of segments based on the impact values of the corresponding subset of the plurality of points. The computing device is further configured to store the attribute values in the memory device. In some implementations, a computing device performs a method with corresponding steps. In some implementations, a non-transitory computer readable medium has instructions stored thereon, where the instructions, when executed by at least one processor, cause a device to perform corresponding operations.

In some implementations, a system includes a memory device, and a computing device communicatively coupled to the memory device. The computing device is configured to obtain segment values for each of a plurality of segments of an area, obtain outage values for each of a plurality of trees in the area, and obtain geospatial data for the area. The computing device is also configured to determine a subset of the plurality of trees within each segment of the plurality of segments based on the geospatial data. Further, the computing device is configured to determine, for each of the plurality of segments, a risk value based on each segment's corresponding segment value and the outage values of the subset of the plurality of trees determined within each segment. The computing device is also configured to store the risk values in the memory device. In some implementations, a computing device performs a method with corresponding steps. In some implementations, a non-transitory computer readable medium has instructions stored thereon, where the instructions, when executed by at least one processor, cause a device to perform corresponding operations.

In some implementations, a computing device may obtain geospatial data for an area, and may generate classification data based on classifying a plurality of points of the geospatial data. The computing device may also generate a plurality of segments of the area based on the classification data, where each of the plurality of segments includes a subset of the plurality of points. The computing device may also determine an impact value for each of the plurality of points based on the classification data. Further, the computing device may determine an attribute value for each of the plurality of segments based on the impact values of the corresponding subset of the plurality of points. In some examples, the computing device determines a risk value for a classified point based on one or more segment attribute values.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a memory device; and
a computing device communicatively coupled to the memory device, wherein the computing device is configured to:
obtain geospatial data for an area;
generate classification data based on classifying a plurality of points of the geospatial data;
generate a plurality of segments of the area based on the classification data, where each of the plurality of segments includes a subset of the plurality of points;
determine an impact value for each of the plurality of points based on the classification data;
determine an attribute value for each of the plurality of segments based on the impact values of the corresponding subset of the plurality of points; and
store the attribute values in the memory device.

2. The system of claim 1, wherein the computing device is configured to determine the impact value for each of the plurality of points based on at least one attribute of the classified points within each segment.

3. The system of claim 2, wherein the at least one attribute of the classified points within each segment comprises at least one of a slope, a height, an offset, and a region.

4. The system of claim 2, wherein the computing device is configured to:
assign each of the plurality of points to a bin based on the at least one attribute of the classified points within each segment;
determine a bin value for each bin based on a number of the plurality of points assigned to each bin; and
determine the impact value for each of the plurality of points based on the bin value.

5. The system of claim 1, wherein the computing device is configured to:
determine a segment location for at least one of the plurality of segments;
determine a structure location based on the geospatial data;
determine a slope value based on the segment location, the structure location, and the attribute value corresponding to the at least one segment;
determine a front row value based on the segment location, the structure location, and the attribute value corresponding to the at least one segment;
determine a fall distance value based on the segment location, the structure location, and the attribute value corresponding to the at least one segment;
determine an exposure value based on the segment location and a second attribute value corresponding to the at least one segment;
determine a segment value for the at least one of the plurality of segments based on the slope value, the front row value, the fall distance value, and the exposure value; and
store the segment value in the memory device.

6. The system of claim 1, wherein the computing device is configured to classify at least a portion of the plurality of points as trees.

7. The system of claim 1, wherein the computing device is configured to:
obtain segment values for each of the plurality of segments of the area;
obtain outage values for each of a plurality of trees in the area;
obtain geospatial data for the area;
determine a subset of the plurality of trees within each segment of the plurality of segments based on the geospatial data;
determine, for each of the plurality of segments, a risk value based on each segment's corresponding segment value and the outage values for the subset of the plurality of trees determined within each segment; and
store the risk values in the memory device.

8. The system of claim 7, wherein the computing device is configured to transmit at least a portion of the risk values to another computing device.

9. The system of claim 1, wherein the geospatial data is light detection and ranging data.

10. A method by a computing device comprising:
obtaining geospatial data for an area;
generating classification data based on classifying a plurality of points of the LIDAR data;
generating a plurality of segments of the area based on the classification data, where each of the plurality of segments includes a subset of the plurality of points;
determining an impact value for each of the plurality of points based on the classification data;
determining an attribute value for each of the plurality of segments based on the impact values of the corresponding subset of the plurality of points; and
storing the attribute values in a memory device.

11. The method of claim 10, comprising determining the impact value for each of the plurality of points based on at least one attribute of the classified points within each segment.

12. The method of claim 11, comprising:
assigning each of the plurality of points to a bin based on the at least one attribute of the classified points within each segment;
determining a bin value for each bin based on a number of the plurality of points assigned to each bin; and
determine the impact value for each of the plurality of points based on the bin value.

13. The method of claim 10, comprising:
determining a segment location for at least one of the plurality of segments;
determining a structure location based on the geospatial data;
determining a slope value based on the segment location, the structure location, and the attribute value corresponding to the at least one segment;
determining a front row value based on the segment location, the structure location, and the attribute value corresponding to the at least one segment;
determining a fall distance value based on the segment location, the structure location, and the attribute value corresponding to the at least one segment;
determining an exposure value based on the segment location and a second attribute value corresponding to the at least one segment;
determining a segment value for the at least one of the plurality of segments based on the slope value, the front row value, the fall distance value, and the exposure value; and
storing the segment value in the memory device.

14. The method of claim 10, wherein at least a portion of the plurality of points are classified as trees.

15. The method of claim 10, comprising:
obtaining segment values for each of the plurality of segments of the area;
obtaining outage values for each of a plurality of trees in the area;
obtaining geospatial data for the area;
determining a subset of the plurality of trees within each segment of the plurality of segments based on the geospatial data;
determining, for each of the plurality of segments, a risk value based on each segment's corresponding segment value and the outage values for the subset of the plurality of trees determined within each segment; and
storing the risk values in the memory device.

16. The method of claim 10, wherein the geospatial data is light detection and ranging data.

17. A non-transitory computer readable medium having instructions stored thereon, wherein the instructions, when executed by at least one processor, cause a device to perform operations comprising:
obtaining geospatial data for an area;
generating classification data based on classifying a plurality of points of the LIDAR data;
generating a plurality of segments of the area based on the classification data, where each of the plurality of segments includes a subset of the plurality of points;
determining an impact value for each of the plurality of points based on the classification data;
determining an attribute value for each of the plurality of segments based on the impact values of the corresponding subset of the plurality of points; and
storing the attribute values in a memory device.

18. The non-transitory computer readable medium of claim 17, wherein the instructions, when executed by the at least one processor, cause the device to determine the impact value for each of the plurality of points based on at least one attribute of the classified points within each segment.

19. The non-transitory computer readable medium of claim 17, wherein the instructions, when executed by the at least one processor, cause the device to perform operations comprising:
obtaining segment values for each of the plurality of segments of the area;
obtaining outage values for each of a plurality of trees in the area;
obtaining geospatial data for the area;
determining a subset of the plurality of trees within each segment of the plurality of segments based on the geospatial data;
determining, for each of the plurality of segments, a risk value based on each segment's corresponding segment value and the outage values for the subset of the plurality of trees determined within each segment; and
storing the risk values in the memory device

20. The non-transitory computer readable medium of claim 17, wherein the instructions, when executed by the at least one processor, cause the device to perform operations comprising:
determining a segment location for at least one of the plurality of segments;
determining a structure location based on the geospatial data;
determining a slope value based on the segment location, the structure location, and the attribute value corresponding to the at least one segment;
determining a front row value based on the segment location, the structure location, and the attribute value corresponding to the at least one segment;
determining a fall distance value based on the segment location, the structure location, and the attribute value corresponding to the at least one segment;
determining an exposure value based on the segment location and a second attribute value corresponding to the at least one segment;
determining a segment value for the at least one of the plurality of segments based on the slope value, the front row value, the fall distance value, and the exposure value; and
storing the segment value in the memory device.
